(19) United States
(12) Patent Application Publication
(10) Pub. No.: US 2025/0112251 A1
(43) Pub. Date: Apr. 3, 2025

(54) SYSTEMS AND METHODS FOR REDUCING DAMAGE ON A METAL PLATE STACK

(71) Applicant: HYDROGENICS CORPORATION, Mississauga (CA)

(72) Inventors: Hong CAO, Mississauga (CA); Rainey Yu WANG, Richmond Hill (CA); Nathaniel Ian JOOS, Toronto (CA)

(21) Appl. No.: 18/900,004

(22) Filed: Sep. 27, 2024

Related U.S. Application Data
(60) Provisional application No. 63/586,962, filed on Sep. 29, 2023.

(51) Int. Cl. H01M 8/0247; B23K 26/38; H01M 8/0206

(52) U.S. Cl. CPC H01M 8/0247; B23K 26/38; H01M 8/0206

(57) ABSTRACT

The present disclosure relates to systems and methods for reducing and/or preventing damage to metal plate stacks in fuel cell stacks. The present disclosure relates to methods of minimizing electrical shorting due to debris and/or burrs from laser cutting, sharp edges from laser cutting, and/or over-compression of a backfeed and/or a frontfeed ports.

### CROSS-REFERENCE TO RELATED APPLICATIONS

This nonprovisional application claims the benefit and priority, under 35 U.S.C. § 119(e) and any other applicable laws or statutes, to U.S. Provisional Application Ser. No. 63/586,962 filed on Sep. 29, 2023, the entire disclosure of which is hereby expressly incorporated herein by reference.

### TECHNICAL FIELD

The present disclosure relates to fuel cell systems, in particular systems and methods for reducing and/or preventing damage to metal plate stacks caused by electrical shorting and/or debris.

### BACKGROUND

Vehicles and/or powertrains use fuel cells and/or fuel cell stacks for their power needs. A fuel cell produces electrical energy in the form of direct current (DC) from electrochemical reactions that take place in the fuel cell. A fuel cell engine comprising the fuel cells may be powered by hydrogen or a hydrogen-rich, conventional fuel, such as methanol, gasoline, diesel, or gasified coal.

The typical fuel cell is comprised of many assemblies compressed and bound into a stack. The fuel cell includes a multi-component membrane electrode assembly (MEA) that has an anode, a cathode, and an electrolyte. Typically, the anode, the cathode, and the electrolyte of the membrane electrode assembly (MEA) are configured in a multi-layer arrangement that enables the electrochemical reaction to consume hydrogen via contact with a gas diffusion layer (GDL). The fuel cell typically includes a GDL positioned on both sides of the MEA. Bipolar plates (BPP) often reside on either side of the GDLs and separate the individual electrolytic cells of the stack from one another.

Metal plates are typically used as bipolar plates because they are lighter, thinner, and usually less costly than graphite options. Since they are light, metal bipolar plates can reduce fuel cell stack mass power density. Further, the metal bipolar plates can be manufactured through relatively low-cost metal processes such as metal forming, laser cutting, and welding. Metal processes such as metal forming, laser cutting, and welding are utilized at different locations such as at the bipolar plate perimeters, inlet ports, outlet ports, backfeed ports, frontfeed ports, and/or near port areas to form the necessary features during the metal bipolar plate manufacturing process. However, following the conventional metal processes, the metal bipolar plate can cause electrical shorting and affect the structure of the MEA. The electrical shorting may be due to debris and/or burrs from laser cutting, sharp edges from laser cutting, and/or from over-compression of a backfeed and/or a frontfeed port.

To overcome the challenges described above, the present disclosure provides systems and methods to manufacture and/or utilize metal bipolar plates in a manner that reduces, minimizes, and/or negates damage to them.

### SUMMARY

Embodiments of the present disclosure are included to meet these and other needs.

In one aspect, the disclosure is directed to a fuel cell comprising a bipolar plate comprising an upper surface and a bottom surface, the upper surface configured to be arch-shaped, and a MEA in contact with the upper surface. The laser cutting maybe implemented at the lower surface.

In some embodiments, the bottom surface maybe positioned lower than the upper surface by more than about 0.2 mm. In some embodiments, the bipolar plate may comprise a metal.

In some embodiments, the fuel cell may further comprise a flat sheet positioned between the upper surface and the MEA at a frontfeed port or under a gasket. In some embodiments, the flat sheet may comprise a metal. In some embodiments, the flat sheet may comprise an inorganic material or a composite material.

In another aspect, the disclosure is directed to a fuel cell comprising a bipolar plate comprising an upper surface and a lower stair cut, the upper surface configured to be arch-shaped, and a MEA in contact with the upper surface. The laser cutting maybe implemented at a lower surface of the bipolar plate.

In some embodiments, the lower stair cut may comprise a stair height larger than about 0.2 mm. In some embodiments, the bipolar plate may comprise a metal.

In some embodiments, the fuel cell may further comprise a flat sheet positioned between the upper surface and the MEA at a frontfeed port or under a gasket. In some embodiments, the flat sheet may comprise a metal. In some embodiments, the flat sheet may comprise an inorganic material or a composite material.

In another aspect, the disclosure is directed to a fuel cell comprising a bipolar plate comprising an upper surface and an edge stair cut, the upper surface configured to be a straight line, and a MEA in contact with the upper surface. The laser cutting maybe implemented at an edge of the bipolar plate.

In some embodiments, the edge stair cut may comprise a step positioned at a step distance below the upper surface, the step distance comprising height larger than about 0.2 mm. In some embodiments, the bipolar plate may comprise a metal.

In some embodiments, the MEA may be positioned on a first side of the bipolar plate and a channel-like piece formed via a metal forming process may be positioned on a second side of the bipolar plate at a frontfeed port or under a gasket. In some embodiments, the bipolar plate may be a first flat bipolar plate and the fuel cell may further comprise a second flat bipolar plate.

In some embodiments, the channel-like piece may be positioned in between the first and the second flat bipolar plates. In some embodiments, the channel-like piece may have a semi-circle, triangle, trapezoid, rectangular, wavy, or a square shape. In some embodiments, the channel-like piece may comprise a metal.

### BRIEF DESCRIPTION OF THE DRAWINGS

These and other features, aspects, and advantages of the present invention will become better understood when the following detailed description is read with reference to the accompanying drawings, in which like characters represent like parts throughout the drawings, wherein:

FIG. 1A is a schematic view of an exemplary fuel cell system including an air delivery system, a hydrogen delivery system, and a fuel cell module including a stack of multiple fuel cells;

FIG. 1B is a cutaway view of an exemplary fuel cell system including an air delivery system, hydrogen delivery systems, and a plurality of fuel cell modules each including multiple fuel cell stacks;

FIG. 1C is a perspective view of an exemplary repeating unit of a fuel cell stack of the fuel cell system of FIG. 1A;

FIG. 1D is a cross-sectional view of an exemplary repeating unit of the fuel cell stack of FIG. 1C;

FIG. 2 is an illustration of the debris and/or burrs on an MEA of the fuel cell causing electrical shorting between neighboring anode and cathode metal bipolar plates (BPP);

FIG. 3A is an illustration of a bipolar plate (BPP) formed by a method of laser cutting used on the metal bipolar plates (BPP) at a high surface;

FIG. 3B is an illustration of the metal bipolar plates (BPP) of FIG. 3A positioned under an MEA;

FIG. 3C is an illustration of bipolar plate (BPP) formed by a method of laser cutting used on the metal bipolar plates (BPP) at a bottom surface;

FIG. 3D is an illustration of the metal bipolar plates (BPP) of FIG. 3C positioned under an MEA;

FIG. 4A is an illustration of a bipolar plate (BPP) formed by a method of laser cutting used on the metal bipolar plates (BPP) comprising forming a lower stair cut;

FIG. 4B is an illustration of the metal bipolar plates (BPP) of FIG. 4A positioned under an MEA;

FIG. 5A is an illustration of a bipolar plate (BPP) formed by a method of laser cutting used on the metal bipolar plates (BPP) comprising a forming a straight cut at an edge of the bipolar plates;

FIG. 5B is an illustration of the metal bipolar plates (BPP) of FIG. 5A positioned under an MEA;

FIG. 5C is an illustration of a bipolar plate (BPP) formed by a method of laser cutting used on the metal bipolar plates (BPP) comprising forming an edge stair cut;

FIG. 5D is an illustration of the metal bipolar plates (BPP) of FIG. 5C positioned under an MEA;

FIG. 6A is an illustration of a high stress concentration on the MEA comprising a backfeed port.

FIG. 6B is an illustration of a low stress concentration on the MEA comprising a underfeed or frontfeed port,

FIG. 6C is an illustration of a channel-like piece that can be laser welded, glued, taped, and/or attached to the bipolar plates (BPP) to form the underfeed or frontfeed port, and

FIG. 7 is an illustration of the underfeed or frontfeed port with a gasket positioned under the bipolar plates (BPP).

### DETAILED DESCRIPTION

The present disclosure provides systems and methods for reducing and/or preventing damage to metal plate stacks caused by electrical shorting and/or debris.

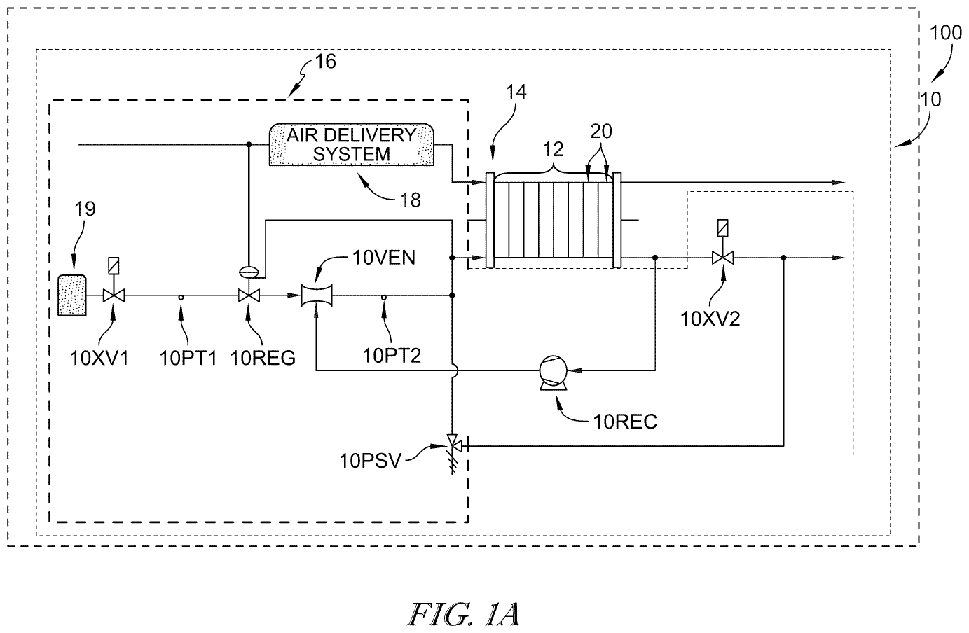

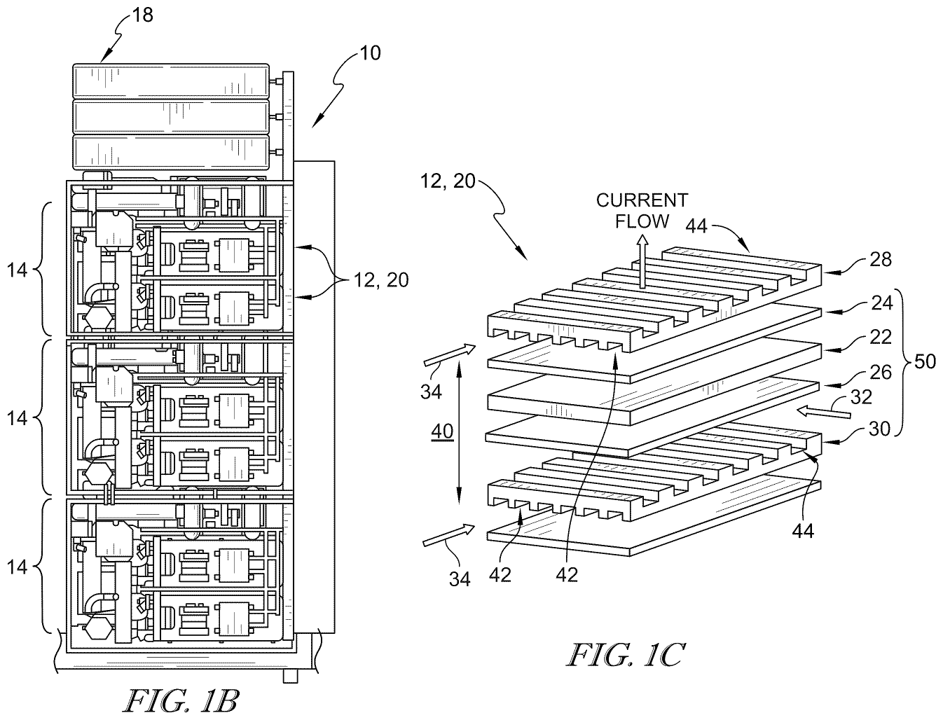

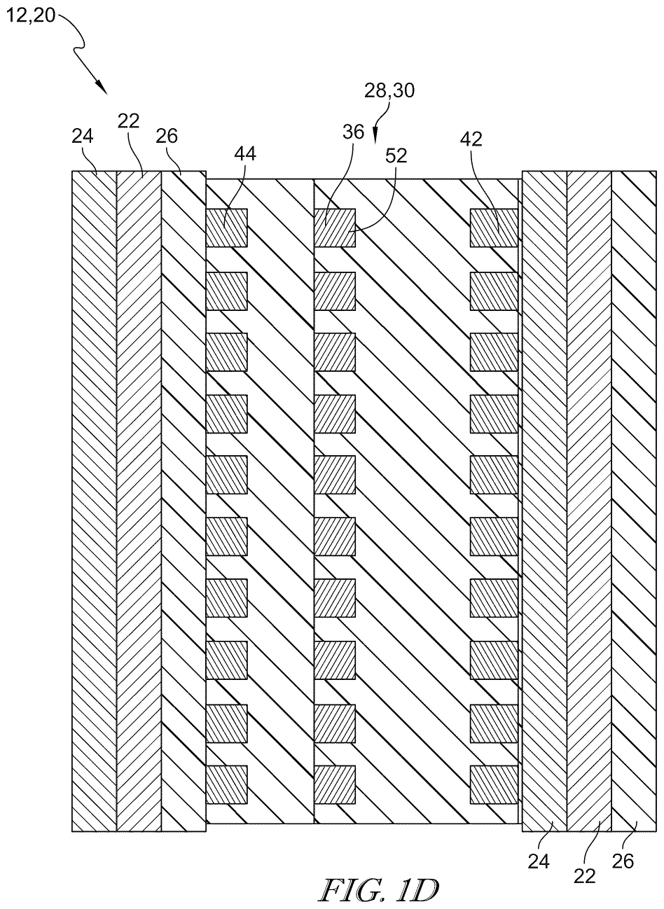

As shown in FIG. 1A, fuel cell systems 10 often include one or more fuel cell stacks 12 (“STK”) or fuel cell modules 14 connected to a balance of plant (BOP) 16, including various components, to support the electrochemical conversion, generation, and/or distribution of electrical power to help meet modern day industrial and commercial needs in an environmentally friendly way. As shown in FIGS. 1B and 1C, fuel cell systems 10 may include fuel cell stacks 12 comprising a plurality of individual fuel cells 20. Each fuel cell stack 12 may house a plurality of fuel cells 20 assembled together in series. The fuel cell system 10 may include one or more fuel cell modules 14 as shown in FIGS. 1A and 1B.

Each fuel cell module 14 may include a plurality of fuel cell stacks 12 and/or a plurality of fuel cells 20. The fuel cell module 14 may also include a suitable combination of associated structural elements, mechanical systems, hardware, firmware, and/or software that is employed to support the function and operation of the fuel cell module 14. Such items include, without limitation, piping, sensors, regulators, current collectors, seals, valves, and insulators.

The fuel cells 20 in the fuel cell stacks 12 may be stacked together to multiply and increase the voltage output of a single fuel cell stack 12. The number of fuel cell stacks 12 in a fuel cell system 10 can vary depending on the amount of power required to operate the fuel cell system 10 and meet the power need of any load. The number of fuel cells 20 in a fuel cell stack 12 can vary depending on the amount of power required to operate the fuel cell system 10 including the fuel cell stacks 12.

The number of fuel cells 20 in each fuel cell stack 12 or fuel cell system 10 can be any number. For example, the number of fuel cells 20 in each fuel cell stack 12 may range from about 100 fuel cells to about 1000 fuel cells, including any specific number or range of number of fuel cells 20 comprised therein (e.g., about 200 to about 800). In an embodiment, the fuel cell system 10 may include about 20 to about 1000 fuel cells stacks 12, including any specific number or range of number of fuel cell stacks 12 comprised therein (e.g., about 200 to about 800). The fuel cells 20 in the fuel cell stacks 12 within the fuel cell module 14 may be oriented in any direction to optimize the operational efficiency and functionality of the fuel cell system 10.

The fuel cells 20 in the fuel cell stacks 12 may be any type of fuel cell 20. The fuel cell 20 may be a polymer electrolyte membrane or proton exchange membrane (PEM) fuel cell, an anion exchange membrane fuel cell (AEMFC), an alkaline fuel cell (AFC), a molten carbonate fuel cell (MCFC), a direct methanol fuel cell (DMFC), a regenerative fuel cell (RFC), a phosphoric acid fuel cell (PAFC), or a solid oxide fuel cell (SOFC). In an exemplary embodiment, the fuel cells 20 may be a polymer electrolyte membrane or proton exchange membrane (PEM) fuel cell or a solid oxide fuel cell (SOFC).

In an embodiment shown in FIG. 1C, the fuel cell stack 12 includes a plurality of proton exchange membrane (PEM) fuel cells 20. Each fuel cell 20 includes a single membrane electrode assembly (MEA) 22 and gas diffusion layers (GDL) 24, 26 on both sides of the membrane electrode assembly (MEA) 22 (see FIG. 1C). The fuel cell 20 further includes a bipolar plate (BPP) 28, 30 on the external side of each gas diffusion layers (GDL) 24, 26, as shown in FIG. 1C. The above-mentioned components, in particular the bipolar plate 30, the gas diffusion layer (GDL) 26, the membrane electrode assembly (MEA) 22, and the gas diffusion layer (GDL) 24 comprise a single repeating unit 50.

Referring to FIGS. 1C and 1D, the bipolar plates (BPP) 28, 30 are responsible for the transport of reactants, such as fuel 32 (e.g., hydrogen) or oxidant 34 (e.g., oxygen, air), and cooling fluid 36 (e.g., coolant and/or water) in a fuel cell 20. The bipolar plates (BPP) 28, 30 can uniformly distribute reactants 32, 34 to an active area 40 of each fuel cell 20 through oxidant flow fields 42 and/or fuel flow fields 44 formed on outer surfaces of the bipolar plates (BPP) 28, 30. The active area 40, where the electrochemical reactions occur to generate electrical power produced by the fuel cell 20, is centered, when viewing the stack 12 from a top-down perspective, within the membrane electrode assembly (MEA) 22, the gas diffusion layers (GDL) 24, 26, and the bipolar plate (BPP) 28, 30.

The bipolar plates (BPP) 28, 30 may each be formed to have reactant flow fields 42, 44 formed on opposing outer surfaces of the bipolar plate (BPP) 28, 30, and formed to have coolant flow fields 52 located within the bipolar plate (BPP) 28, 30, as shown in FIG. 1D. For example, the bipolar plate (BPP) 28, 30 can include fuel flow fields 44 for transfer of fuel 32 on one side of the plate 28, 30 for interaction with the gas diffusion layer (GDL) 26, and oxidant flow fields 42 for transfer of oxidant 34 on the second, opposite side of the plate 28, 30 for interaction with the gas diffusion layer (GDL) 24. As shown in FIG. 1D, the bipolar plates (BPP) 28, 30 can further include coolant flow fields 52 formed within the plate (BPP) 28, 30, generally centrally between the opposing outer surfaces of the plate (BPP) 28, 30. The coolant flow fields 52 facilitate the flow of cooling fluid 36 through the bipolar plate (BPP) 28, 30 in order to regulate the temperature of the plate (BPP) 28, 30 materials and the reactants. The bipolar plates (BPP) 28, 30 are compressed against adjacent gas diffusion layers (GDL) 24, 26 to isolate and/or regulate one or more reactants 32, 34 within their respective pathways 44, 42 and maintain electrical conductivity, which is required for robust operation of the fuel cell 20 (see FIGS. 1C and 1D).

The fuel cell system 10 described herein, may be used in stationary and/or immovable power system, such as industrial applications and power generation plants. The fuel cell system 10 may also be implemented in conjunction with an air delivery system 18. Additionally, the fuel cell system 10 may also be implemented in conjunction with a hydrogen delivery system and/or a source of hydrogen 19 such as a pressurized tank, including a gaseous pressurized tank, cryogenic liquid storage tank, chemical storage, physical storage, stationary storage, an electrolysis system, or an electrolyzer. In one embodiment, the fuel cell system 10 is connected and/or attached in series or parallel to a hydrogen delivery system and/or a source of hydrogen 19, such as one or more hydrogen delivery systems and/or sources of hydrogen 19 in the BOP 16 (see FIG. 1A). In another embodiment, the fuel cell system 10 is not connected and/or attached in series or parallel to a hydrogen delivery system and/or a source of hydrogen 19.

In some embodiments (see FIG. 1A), the fuel cell system 10 may include an on/off valve 10XV1, a pressure transducer 10PT1, a mechanical regulator 10REG, and a venturi 10VEN arranged in operable communication with each other and downstream of the hydrogen delivery system and/or source of hydrogen 19. The pressure transducer 10PT1 may be arranged between the on/off valve 10XV1 and the mechanical regulator 10REG. In some embodiments, a proportional control valve may be utilized instead of a mechanical regulator 10REG. In some embodiments, a second pressure transducer 10PT2 is arranged downstream of the venturi 10VEN, which is downstream of the mechanical regulator 10REG.

In some embodiments (see FIG. 1A), the fuel cell system 10 may further include a recirculation pump 10REC downstream of the stack 12 and operably connected to the venturi 10VEN. The fuel cell system 10 may also include a further on/off valve 10XV2 downstream of the stack 12, and a pressure transfer valve 10PSV.

The present fuel cell system 10 may also be comprised in mobile applications. In an exemplary embodiment, the fuel cell system 10 is in a vehicle and/or a powertrain 100. A vehicle 100 comprising the present fuel cell system 10 may be an automobile, a pass car, a bus, a truck, a train, a locomotive, an aircraft, a light duty vehicle, a medium duty vehicle, or a heavy-duty vehicle. Type of vehicles 100 can also include, but are not limited to commercial vehicles and engines, trains, trolleys, trams, planes, buses, ships, boats, and other known vehicles, as well as other machinery and/or manufacturing devices, equipment, installations, among others.

The vehicle and/or a powertrain 100 may be used on roadways, highways, railways, airways, and/or waterways. The vehicle 100 may be used in applications including but not limited to off highway transit, bobtails, and/or mining equipment. For example, an exemplary embodiment of mining equipment vehicle 100 is a mining truck, trains, forklifts, or a mine haul truck.

In addition, it may be appreciated by a person of ordinary skill in the art that the fuel cell system 10, fuel cell stack 12, and/or fuel cell 20 described in the present disclosure may be substituted for any electrochemical system, such as an electrolysis system (e.g., an electrolyzer), an electrolyzer stack, and/or an electrolyzer cell (EC), respectively. As such, in some embodiments, the features and aspects described and taught in the present disclosure regarding the fuel cell system 10, stack 12, or cell 20 also relate to an electrolyzer, an electrolyzer stack, and/or an electrolyzer cell (EC). In further embodiments, the features and aspects described or taught in the present disclosure do not relate, and are therefore distinguishable from, those of an electrolyzer, an electrolyzer stack, and/or an electrolyzer cell (EC).

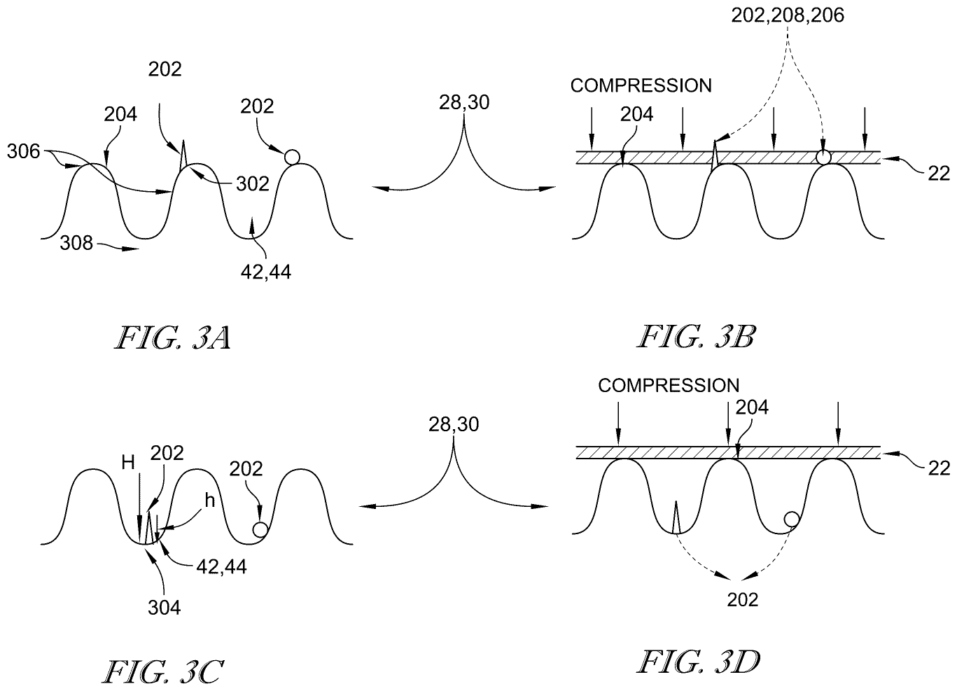

Laser cutting processes are typically utilized to form the metal bipolar plates (BPP) 28, 30. However, the laser cutting processes do not always result in a clean cut. As shown in FIGS. 3A and 3B, the bipolar plates (BPP) 28, 30 formed by laser cutting may comprise a debris and/or sharp burr 202 that is fused to the metal of the bipolar plates (BPP) 28, 30. Such debris and/or sharp burr 202 may be formed due to factors including but not limited to a thermal loop designed to control the temperature, high cutting speed, and/or focal length changes associated with laser movement and/or geometry (e.g., shape) of the bipolar plates (BPP) 28, 30.

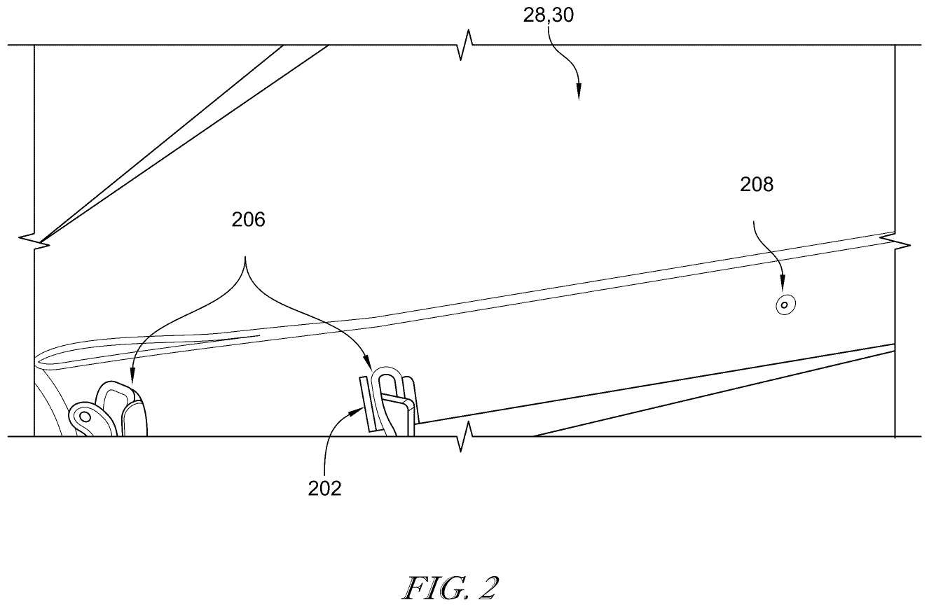

As seen in FIGS. 2 and 3A, the debris and/or burrs 202 can further cause electrical shorting 206 and/or deformities 208 between neighboring anode and cathode bipolar plates (BPP) 28, 30. These deformities 208 can reduce the fuel cell stack performance and impact its safety. The deformities 208 may also be formed from piercing and/or poking of the debris and/or burrs 202. Poking is a results of an increase in the stress concentration at a point of contact between the bipolar plates (BPP) 28, 30 and the MEA 22. Piercing is a result of the formation of a hole at a point of contact between the bipolar plates (BPP) 28, 30 and the MEA 22.

As shown in FIGS. 3A and 3B, a landing surface 204 is a location where the bipolar plates (BPP) 28, 30 contacts the MEA 22. When the debris and/or burrs 202 are located near the top of the landing surface 204 of the bipolar plates (BPP) 28, 30 that is in contact with the MEA 22, the debris and/or burrs 202 can impact fuel cell stack performance. For example, the debris and/or burrs 202 can pierce the MEA 22 that is under stack compression during fuel cell operation (see FIGS. 2, 3A, 3B).

Referring to FIGS. 3A and 3B, the metal bipolar plates (BPP) 28, 30 typically comprise an arch-shaped structure 306 at the landing surface 204. Due to the arch-shaped structure 306 of the metal bipolar plate (BPP) 28, 30, the MEA 22 may be in contact with a smaller landing surface 204 at a backfeed port structure 308 compared to a graphite bipolar plate (BPP). This is because the graphite bipolar plate (BPP) is typically a flat structure without any arch-shapes or undulations. Thus, the use of the metal bipolar plate (BPP) 28, 30 comprising the arch-shaped structure 306 creates more stress concentration compared to a flat graphite bipolar plate (BPP) 28, 30. As a result, the MEA 22 may be impacted (e.g., poked or pierced) by deformities 208 and/or electrically shorting 206, as illustrated in FIGS. 2, 3B. Therefore, for the successful utilization of metal bipolar plates (BPP) 28, 30 in a fuel cell stack 12 or system 10, it is important to develop methods to reduce the electrical shorting 206 and/or deformity 208 formation.

The debris and/or burr 202 (see FIG. 3A) formed by laser cutting of the metal bipolar plates (BPP) 28, 30 are typically submillimeter in size. However, in some embodiments, the debris and/or burr 202 may range from about 1 μm to about 2 mm in size, including any size or range of size comprised therein. For example, the debris and/or burr 202 may range from about 1 μm to about 10 μm, about 10 μm to about 25 μm, about 25 μm to about 50 μm, about 50 μm to about 100 μm, about 100 μm to about 150 μm, about 150 μm to about 200 μm in size, about 200 μm to about 500 μm in size, about 500 μm to about 1 mm in size, or about 1 mm to about 2 mm in size.

The height and/or location of the debris and/or burr 202 (see FIG. 3A) on the metal bipolar plates (BPP) 28, 30 is critical in predicting electrical shorting 206. Typically, as shown in FIGS. 3A and 3B, a method of using metal bipolar plates (BPP) 28, 30 comprises laser cutting the metal bipolar plates (BPP) 28, 30 at a top or an upper surface 302 comprising the arch-shaped structure 306. The process of laser-cutting the metal bipolar plates (BPP) 28, 30 comprises implementing a laser start-stop location. When the laser start-stop location of a laser cutting profile is near the top of the landing surface 204, the debris and/or burr 202 formed may be in contact with the MEA 22. Therefore, such debris and/or burr 202 is likely to pierce and/or poke the MEA 22 and cause electrical shorting 206 and deformities 208 under stack compression (see FIG. 2).

In one embodiment, as shown in FIGS. 3C and 3D, the method comprises laser cutting the metal bipolar plates (BPP) 28, 30 at a low or a bottom surface 304 of the flow field or channel 42, 44. The debris and/or burr 202 is not likely to pierce the MEA 22 and cause electrical shorting 206 or piercings 208 (see FIG. 2) when the height ‘H’ of the flow field or channel 42, 44 is at least more than the height ‘h’ of the laser cut debris and/or burr 202 (see FIG. 3C). Therefore, the debris and/or burr 202 located at the bottom surface 304 may not reach the MEA 22 under stack compression (see FIG. 3D).

Further, as shown in FIGS. 3C and 3D, when the laser cutting is implemented at the bottom of the channel 42, 44, the debris and/or burr 202 does not reach the MEA 22 as long as the height ‘h’ of the debris is lower than the height ‘H’ of the channel 42, 44. However, this method may not be implemented where there is no such bottom surface 304 available. For example, if the metal bipolar plates (BPP) 28, 30 is flat or when the laser cutting is implemented at the top of the channel 42, 44, the location of the laser cutting will be in contact with the MEA 22.

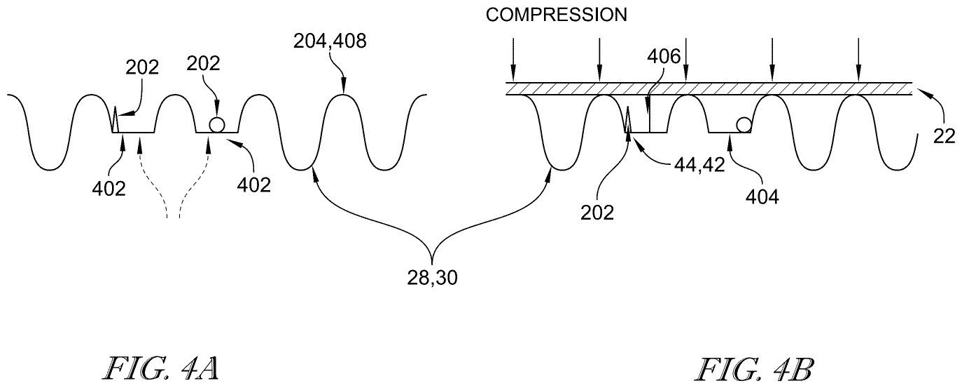

In one embodiment, as shown in FIGS. 4A and 4B the method of using the metal bipolar plates (BPP) 28, 30 comprises forming a lower stair cut. The method comprises designing a lower stair cut 402 to reduce the piercing and/or poking effect of the debris and/or burr 202 on the MEA 22. The method comprises designing the lower stair cut 402 with a laser cutting profile below an interfacing datum, 408. The interfacing datum 408 is any reference determining the height below which the metal bipolar plates (BPP) 28, 30 may be laser cut to avoid the formation of deformities 208 and/or electrical shorting 206 (see FIG. 2).

The lower stair cut 402 may comprise a stair height 406 that is higher than the size of the debris and/or burr 202 (e.g., greater than about 2 mm). The stair height 406 may depend on the thickness of the metal bipolar plates (BPP) 28, 30. For example, the stair height 406 may range from about 0.2 mm to about 2 mm from a lower stair surface 404, including any height or range of height comprised therein. Laser cutting may be employed at the lower stair surface 404. As shown in FIGS. 4A and 4B, any debris and/or burr 202 formed at the lower stair surface 404 may not reach the MEA 22 under stack compression. Therefore, the debris and/or burr 202 may remain at the bottom of the flow field or channel 42, 44 and not reach the landing surface 204 region.

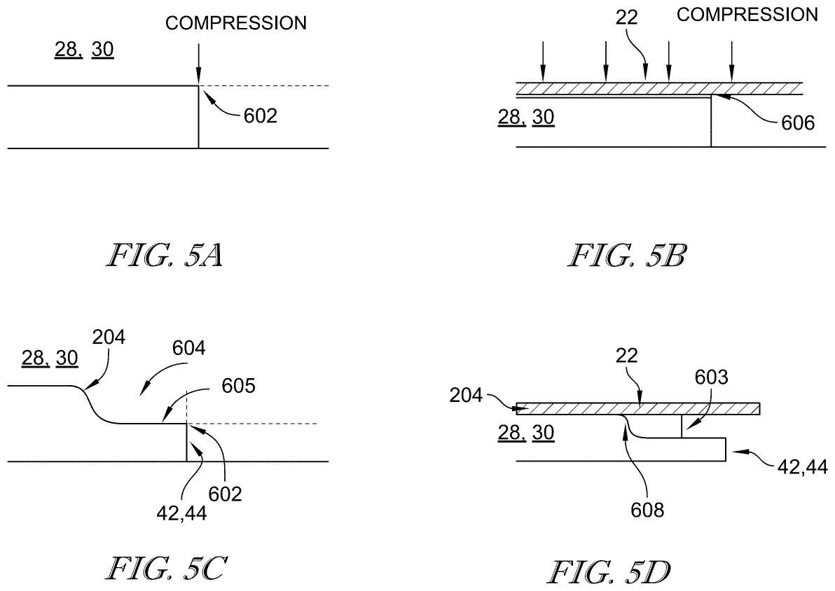

The method of using metal bipolar plates (BPP) 28, 30 typically comprises forming a straight cut at an edge 602 of the metal bipolar plates (BPP) 28, 30 as shown in FIGS. 5A and 5B. As the metal bipolar plates (BPP) 28, 30 are very thin, a straight cut on the bipolar plates (BPP) 28, 30 can lead to an increase in a stress concentration by about 2 MPa to about 8 MPa in pressure on the MEA 22 under stack compression. Such an increased stress concentration can further lead to poking, piercing, and/or electrical shorting 206 between neighboring anode and cathode bipolar plates (BPP) 28, 30.

In one embodiment, as shown in FIGS. 5C and 5D, the method of using metal bipolar plates (BPP) 28, 30 comprises forming an edge stair cut 604. The method comprises forming the edge stair cut 604 at an edge 602. The edge stair cut 604 comprises the formation of a step 605 at a step distance 603 below the landing surface 204. The step distance 603 may be larger than the size of the debris and/or burr 202.

Implementing the edge stair cut 604 (see FIGS. 5C and 5D) at the edge 602 can reduce the stress concentration on the MEA 22 at the edge 602 of the metal bipolar plates (BPP) 28, 30. In some embodiments, the method of forming the edge stair cut 604 may be combined with the method of forming the lower stair cut 402 described above in reference to FIGS. 4A and 4B. Since the metal bipolar plates (BPP) 28, 30 has a smooth contact with the MEA 22 after cutting, the stress concentration 608 on the MEA 22 (see FIG. 5D) is reduced compared to a stress concentration 606 (see FIG. 5B) without the edge stair cut 604. Further, since the metal bipolar plates (BPP) 28, 30 are cut at the edge 602, any debris and/or burr 202 may not reach the MEA 22. This avoids poking and piercing of the MEA 22 and prevents electrical shorting 206 (see FIG. 2) of the metal bipolar plates (BPP) 28, 30.

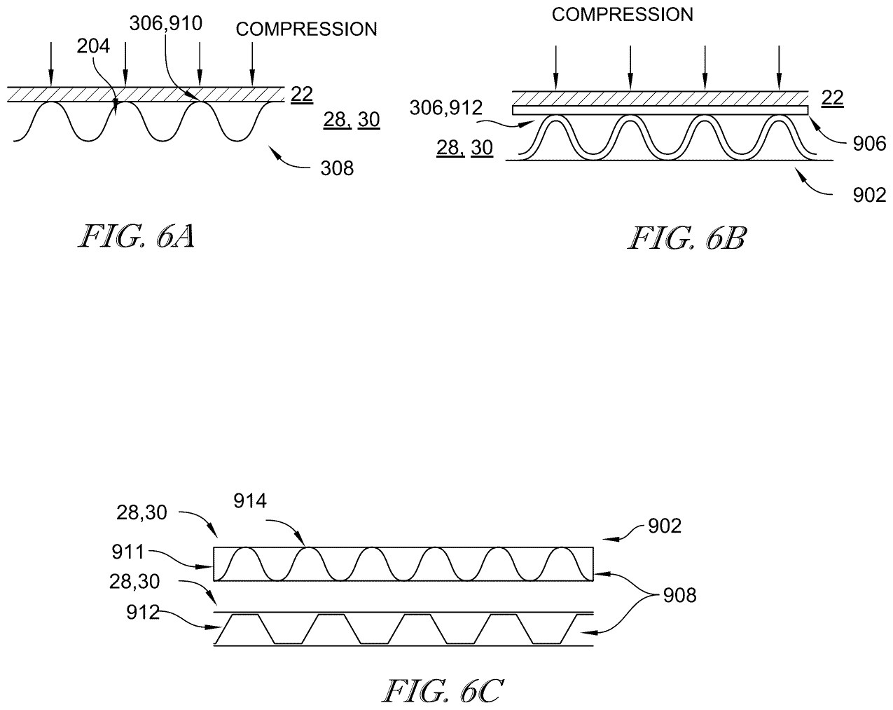

As discussed earlier, the smaller arch-shaped structures 306 of the metal bipolar plates (BPP) 28, 30 at the landing area 204 (see FIG. 3A, 6A) create an increase in stress concentration at the MEA 22. In one embodiment, as shown in FIG. 6B, the backfeed ports 308 (shown in FIG. 6A) are replaced by an underfeed or frontfeed port 902. The backfeed port 308 is defined as a port region where the arch-shaped structures 306 of the metal bipolar plates (BPP) 28, 30 are in direct contact with the MEA 22. The underfeed or frontfeed port 902 is defined as a port region where the arch-shaped structures 306 of the metal bipolar plates (BPP) 28, 30 are not in direct contact with the MEA 22. The underfeed or frontfeed port 902 shown in FIG. 6B is in direct contact with a non-landing flat sheet of material 906 instead of the arch-shaped 306 top landing surface 204 shown in FIG. 6A. Therefore, an underfeed stress concentration 912 at the MEA 22 is reduced compared to a backfeed stress concentration 910 at the MEA 22.

The flat sheet of material 906 (see FIG. 6B) may be a metal sheet. The flat sheet of material 906 may also be comprised of any material, such as a metal, a non-metal, an inorganic material, an organic material, plastic, a composite material, combinations thereof, etc.

The flat sheet of material 906 may have a thickness ranging from about 0.001 mm to about 1 mm, including any thickness or range comprised therein. The thickness of the flat sheet of material 906 may be the same or different from the thickness of the bipolar plates (BPP) 28, 30. The flat sheet of material 906 can be laser welded, glued, taped, and/or attached to anode and cathode bipolar plates (BPP) 28, 30. The flat sheet of material 906 can be laser welded, glued, taped, and/or attached the MEA 22.

The fluids (e.g., fuel, air, and/or coolant) flow through flow fields or channels 42, 44, 52 (shown in FIGS. 1C and 1D) between the bipolar plates (BPP) 28, 30 at the backfeed port 308 (shown in FIG. 6A). The fluids (e.g., fuel, air, and/or coolant) may also flow through flow fields or channels 42, 44, 52 (shown in FIGS. 1C and 1D) between the flat sheet of material 906 and bipolar plates (BPP) 28, 30 at the underfeed or frontfeed port 902 (shown in FIG. 6B). The debris and/or burr 202 may be separated by the flat sheet of material 906 from the MEA 22.

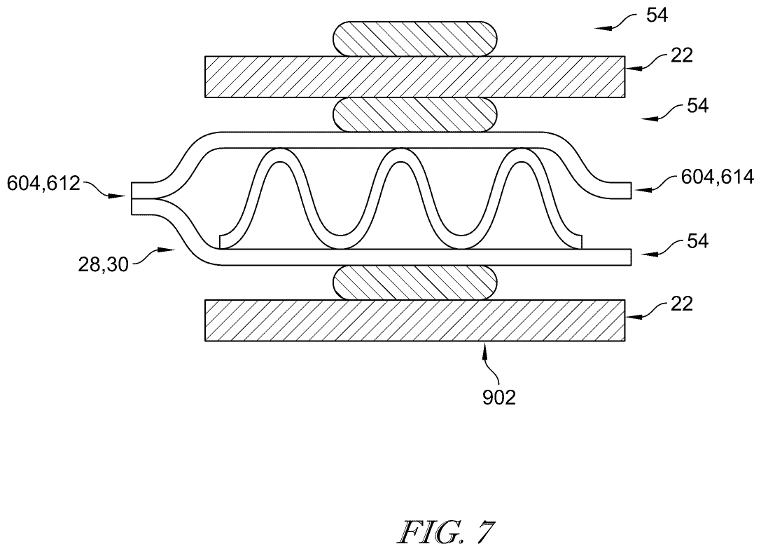

FIG. 7 illustrates the underfeed or frontfeed port 902 with the gaskets 54. The bipolar plates (BPP) 28, 30 comprise a closed edge stair 612 and an open edge stair 614 positioned under one or more gaskets 54. The closed edge stair 612 is the edge stair cut 604 formed when the two bipolar plates (BPP) 28, 30 are in contact with each other after laser cutting. The open edge stair 614 is the edge stair cut 604 formed when the two bipolar plates (BPP) 28, 30 are not in contact with each other after laser cutting.

In some embodiments, the bipolar plates (BPP) 28, 30 may be one or more flat structures separated by an insert 908 (see FIG. 6C) at or near the ports 902 or under the gaskets 54, as shown in FIG. 7. The underfeed or frontfeed port 902 may comprise the bipolar plates (BPP) 28, 30 separated by the insert 908. The insert 908 may be a channel-like piece 908 that can be pre-formed via one or more metal forming processes. For example, the pre-formed channel-like piece 908 can be cut by a laser into strips and then laser welded, glued, taped, and/or attached to bipolar plates (BPP) 28, 30 at the backfeed port 308 or at the frontfeed port 902, as shown in FIGS. 6A-B. Such anode and cathode metal bipolar plates (BPP) 28, 30 can be laser welded, glued, taped, and/or attached together.

A cross-section of the pre-formed channel-like piece 908 can be of any shape. In some embodiments, the shape of the cross-section of the pre-formed channel-like piece 908 may include, but is not limited to a semi-circle 911, a triangle (not shown), a trapezoid 912, a rectangular (not shown), a wavy structure (not shown), and a square (not shown). The cross-section of the pre-formed channel-like piece 908 comprising a wavy structure that may include one or more arched edges 914 similar to the semi-circle 911, but where a width of each arched edge 914 is more than twice its height.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

The above embodiments are described in sufficient detail to enable those skilled in the art to practice what is claimed and it is to be understood that logical, mechanical, and electrical changes may be made without departing from the spirit and scope of the claims. The detailed description is, therefore, not to be taken in a limiting sense.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Specified numerical ranges of units, measurements, and/or values comprise, consist essentially or, or consist of all the numerical values, units, measurements, and/or ranges including or within those ranges and/or endpoints, whether those numerical values, units, measurements, and/or ranges are explicitly specified in the present disclosure or not.

Unless defined otherwise, technical and scientific terms used herein have the same meaning as is commonly understood by one of ordinary skill in the art to which this disclosure belongs. The terms “first,” “second,” “third” and the like, as used herein do not denote any order or importance, but rather are used to distinguish one element from another. The term “or” is meant to be inclusive and mean either or all of the listed items. In addition, the terms “connected” and “coupled” are not restricted to physical or mechanical connections or couplings, and can include electrical connections or couplings, whether direct or indirect.

Moreover, unless explicitly stated to the contrary, embodiments “comprising,” “including,” or “having” an element or a plurality of elements having a particular property may include additional such elements not having that property. The term “comprising” or “comprises” refers to a composition, compound, formulation, or method that is inclusive and does not exclude additional elements, components, and/or method steps. The term “comprising” also refers to a composition, compound, formulation, or method embodiment of the present disclosure that is inclusive and does not exclude additional elements, components, or method steps.

The phrase “consisting of” or “consists of” refers to a compound, composition, formulation, or method that excludes the presence of any additional elements, components, or method steps. The term “consisting of” also refers to a compound, composition, formulation, or method of the present disclosure that excludes the presence of any additional elements, components, or method steps.

The phrase “consisting essentially of” or “consists essentially of” refers to a composition, compound, formulation, or method that is inclusive of additional elements, components, or method steps that do not materially affect the characteristic(s) of the composition, compound, formulation, or method. The phrase “consisting essentially of” also refers to a composition, compound, formulation, or method of the present disclosure that is inclusive of additional elements, components, or method steps that do not materially affect the characteristic(s) of the composition, compound, formulation, or method steps.

Approximating language, as used herein throughout the specification and claims, may be applied to modify any quantitative representation that could permissibly vary without resulting in a change in the basic function to which it is related. Accordingly, a value modified by a term or terms, such as “about,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

It is to be understood that the above description is intended to be illustrative, and not restrictive. For example, the above-described embodiments (and/or aspects thereof) may be used individually, together, or in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

While only certain features of the invention have been illustrated and described herein, many modifications and changes will occur to those skilled in the art. It is, therefore, to be understood that the appended claims are intended to cover all such modifications and changes as fall within the true spirit of the invention.

What is claimed is:

1. A fuel cell comprising:
a bipolar plate comprising an upper surface and a bottom surface, the upper surface configured to be arch-shaped, and
a MEA in contact with the upper surface,
wherein laser cutting is implemented to form the bipolar plate at the lower surface of the bipolar plate.

2. The fuel cell of claim 1, wherein the bottom surface is positioned lower than the upper surface by more than about 0.2 mm.

3. The fuel cell of claim 1, wherein the bipolar plate comprises a metal.

4. The fuel cell of claim 1, further comprising a flat sheet positioned between the upper surface and the MEA at a frontfeed port or under a gasket.

5. The fuel cell of claim 4, wherein the flat sheet comprises a metal.

6. The fuel cell of claim 4, wherein the flat sheet comprises an inorganic material or a composite material.

7. A fuel cell comprising:
a bipolar plate comprising an upper surface and a lower stair cut, the upper surface configured to be arch-shaped, and
a MEA in contact with the upper surface,
wherein laser cutting is implemented to form the bipolar plate at a lower surface of the bipolar plate.

8. The fuel cell of claim 7, wherein the lower stair cut comprises a stair height larger than about 0.2 mm.

9. The fuel cell of claim 7, wherein the bipolar plate comprises a metal.

10. The fuel cell of claim 7, further comprising a flat sheet positioned between the upper surface and the MEA at a frontfeed port or under a gasket.

11. The fuel cell of claim 10, wherein the flat sheet comprises a metal.

12. The fuel cell of claim 10, wherein the flat sheet comprises an inorganic material or a composite.

13. A fuel cell comprising:
a bipolar plate comprising an upper surface and an edge stair cut, the upper surface configured to be a straight line, and
a MEA in contact with the upper surface,
wherein laser cutting is implemented to form the bipolar plate at an edge of the bipolar plate.

14. The fuel cell of claim 13, wherein the edge stair cut comprises a step positioned at a step distance below the upper surface, the step distance comprising a height larger than about 0.2 mm.

15. The fuel cell of claim 13, wherein the bipolar plate comprises a metal.

16. The fuel cell of claim 13, wherein the MEA is positioned on a first side of the bipolar plate and a channel-like piece formed via a metal forming process is positioned on a second side of the bipolar plate at a frontfeed port or under a gasket.

17. The fuel cell of claim 16, wherein the bipolar plate is a first flat bipolar plate and the fuel cell further comprises a second flat bipolar plate.

18. The fuel cell of claim 17, wherein the channel-like piece is positioned in between the first and the second flat bipolar plates.

19. The fuel cell of claim 16, wherein the channel-like piece has a semi-circle, triangle, trapezoid, rectangular, wavy, or a square shape.

20. The fuel cell of claim 18, wherein the channel-like piece comprises a metal.
